(19) United States
(12) Patent Application Publication
(10) Pub. No.: US 2018/0039515 A1
(43) Pub. Date: Feb. 8, 2018

(54) SYSTEMS AND METHODS FOR IDENTIFYING SIMILARITIES IN INSTRUCTIONAL DATA AND CREATING CONSOLIDATED RECORDS THEREOF

(71) Applicant: The Western Union Company, Englewood, CO (US)

(72) Inventors: Kim Crea, Lone Tree, CO (US); Jennifer Grimes, Parker, CO (US); Marilyn Bethke, Greenwood Village, CO (US)

(73) Assignee: The Western Union Company, Englewood, CO (US)

(21) Appl. No.: 15/634,751

(22) Filed: Jun. 27, 2017

Related U.S. Application Data
(63) Continuation-in-part of application No. 10/406,793, filed on Apr. 2, 2003, now abandoned.

(51) Int. Cl. G06F 9/50; G06Q 20/14

(52) U.S. Cl. CPC G06F 9/50; G06Q 20/14

(57) ABSTRACT

Methods herein may include receiving a request to initiate an allocation and transmitting a request for information relating to the allocation, including a quantity and an identification of institutions associated with first and second parties. Methods may also include consolidating the information with information received from other parties into consolidated information. Methods may also include determining from the consolidated information a first aggregate which includes all quantities to be sent to the institution associated with the second party in the consolidated information, and a second aggregate which includes all quantities to be received from the institution associated with the first party in the consolidated information. Methods may also include creating an additive instruction based on the first aggregate, and a subtractive instruction based on the second aggregate. Methods may also include sending the additive instruction and the subtractive instruction to a network in communication with the institutions.

### BRIEF SUMMARY OF THE INVENTION

In one embodiment, a method of identifying similarities in instructional data and creating consolidated records for transmission and effectuation thereof is disclosed. The method may include receiving, at a specialized host computer system, a request to initiate an allocation from a first party to a second party. The method may include transmitting, from the specialized host computer system to a directing computer, a request for information relating to the allocation. The method may include receiving the information relating to the allocation from the directing computer at the specialized host computer system, where the information includes a quantity, an identification of an institution associated with the first party, and an indication of an institution associated with the second party. The method may include consolidating, by the specialized host computer system, the information from the directing computer with information received from other parties making allocations into consolidated information. The method may include determining, from the consolidated information, by the specialized host computer system, a first aggregate which includes the quantity and all quantities to be sent to the institution associated with the second party for other allocations associated with other parties making allocations in the consolidated information. The method may include determining, from the consolidated information, by the specialized host computer system, a second aggregate which includes the quantity and all quantities to be received from the institution associated with the first party for other allocations associated with other parties making allocations in the consolidated information. The method may include creating, by the specialized host computer system, an additive instruction based on the first aggregate that reduces resources from an institution associated with the specialized host computer system and correspondingly increases resources at the institution associated with the second party. The method may include creating, by the specialized host computer system, a subtractive instruction based on the second aggregate that reduces resources from the institution associated with the first party and correspondingly increases resources at the institution associated with the specialized host computer system. The method may include sending both the additive instruction and the subtractive instruction to a network in communication with the institution associated with the first party, the institution associated with the second party, and the institution associated with the specialized host computer system.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIG. 1 illustrates a system for processing transfers from a first party to a second party according to embodiments of the present invention.

FIG. 2 illustrates a payment display screen according to one example of the present invention.

FIG. 3 illustrates an institutional information display screen according to one example of the present invention.

FIG. 4 illustrates a transfer confirmation display screen according to one example of the present invention.

FIG. 5A and FIG. 5B illustrates a terms and conditions display screen according to one example of the present invention.

FIG. 6 illustrates a final confirmation display screen according to one example of the present invention.

FIG. 7 depicts a flow diagram of a method for processing transfers that may be implemented in the system of FIG. 1.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

For example, any detail discussed with regard to one embodiment may or may not be present in all contemplated versions of that embodiment. Likewise, any detail discussed with regard to one embodiment may or may not be present in all contemplated versions of other embodiments discussed herein. Finally, the absence of discussion of any detail with regard to embodiment herein shall be an implicit recognition that such detail may or may not be present in any version of any embodiment discussed herein.

Specific details are given in the following description to provide a thorough understanding of the embodiments. However, it will be understood by one of ordinary skill in the art that the embodiments may be practiced without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

The term “machine-readable medium” includes, but is not limited to transitory and non-transitory, portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Systems and Methods of identifying similarities in instructional data and creating consolidated records for transmission and effectuation thereof are disclosed herein. Though some of the disclosure will relate to particular environments in which embodiments of the invention may be implemented, these environments are merely exemplary for the purposes of explanation.

In some embodiments, one method of the invention may include receiving, at a specialized host computer system, a request to initiate an allocation from a first party to a second party. The method may include transmitting, from the specialized host computer system to a directing computer, a request for information relating to the allocation. The method may include receiving the information relating to the allocation from the directing computer at the specialized host computer system, where the information includes a quantity, an identification of an institution associated with the first party, and an indication of an institution associated with the second party. The method may include consolidating, by the specialized host computer system, the information from the directing computer with information received from other parties making allocations into consolidated information. The method may include determining, from the consolidated information, by the specialized host computer system, a first aggregate which includes the quantity and all quantities to be sent to the institution associated with the second party for other allocations associated with other parties making allocations in the consolidated information. The method may include determining, from the consolidated information, by the specialized host computer system, a second aggregate which includes the quantity and all quantities to be received from the institution associated with the first party for other allocations associated with other parties making allocations in the consolidated information. The method may include creating, by the specialized host computer system, an additive instruction based on the first aggregate that reduces resources from an institution associated with the specialized host computer system and correspondingly increases resources at the institution associated with the second party. The method may include creating, by the specialized host computer system, a subtractive instruction based on the second aggregate that reduces resources from the institution associated with the first party and correspondingly increases resources at the institution associated with the specialized host computer system. The method may include sending both the additive instruction and the subtractive instruction to a network in communication with the institution associated with the first party, the institution associated with the second party, and the institution associated with the specialized host computer system.

For example, many consumers now transact with merchants and other businesses or service providers on-line, either through the Internet or other network. Such networks provide convenient means for consumers to order services, view account activity, make payments, and the like. Some systems even allow consumers to pay merchants from directly from their checking accounts by entering bank account information into display screens. The information is then processed through a banking network, such as the Automated Clearing House (ACH) network. Such systems are limited, however, because the consumer's account is not credited with having satisfied the obligation until the funds are received at the payee's bank. Thus, improved systems are needed that more quickly credit consumers with having satisfied an obligation owed to a payee.

Embodiments of the present invention thus may provide a method of processing a payment from a payer to a payee. The method includes receiving at a host computer system a request to initiate a payment and transmitting from the host computer system to a payer computer a file comprising a display screen configured for receiving, from the payer, information relating to the payment. the method also includes receiving the information from the payer at the host computer system and creating with the host computer system a credit transaction based on the information that debits funds from a transaction processor's bank and credits funds to a bank of the payee. The method further includes creating with the host computer system a debit transaction based on the information that debits funds from a bank of the payer and credits funds to the transaction processor's bank. The method also includes sending both the debit transaction and the credit transaction to a banking network within one banking day. In some embodiments the banking network comprises the Automated Clearing House (ACH) network. The method may include receiving funds at the payee's bank within one banking day of receiving the information from the payer. The method also may include creating with the host computer system a posting statement based on the information and sending the posting statement to a payee computing system. In still other embodiments, the method may include calculating a fee relating to the payment and transmitting a file to the payer computer that includes a display screen that displays the fee to the payer. In still other embodiments, the method may include receiving a request from the payer to abort the transaction and aborting the transaction. The method also may include receiving a notification that the bank of the payer has rejected the transaction, creating a reversal transaction that withdraws funds from the bank of the payee, and sending the debit transaction to the banking network. The method further may include receiving information from other payers similar to the information from the payer and using the notification and the similar information to prepare a debit transaction and a credit transaction. The method may include consolidating the information from the payer with similar information from other payers and using the consolidated information to prepare a debit transaction and a credit transaction.

In other embodiments, a payee computer system includes means for interacting, via a network, with a payer and means for receiving from the payer a request to make a payment to the payee. The payee computer system also may include means for linking the payer to a transaction processor's computer system that is programmed to present a series of payment information receiving screens having branding information relating to the payee. The system may include means for transferring information relating to the payer to the transaction processor's computer system.

In still other embodiments of the invention, a method of receiving payment information from a payer includes interacting, via a network, with the payer, receiving from the payer a request to make a payment to the payee, linking the payer to a transaction processor's computer system that is programmed to present a series of payment information receiving screens having branding information relating to the payee.

In another embodiment of the invention, a system for processing a payment from a payer to a payee includes a host computer system that includes an interface to a payer computer, an interface to a banking network, and an interface to a payee computing system. The host computer system is programmed to receive through the interface to the payer computer a request from the payer to initiate a payment, transmit from the host computer system to the payer computer through the interface to the payer computer a file comprising a display screen configured for receiving information relating to the payment from the payer, receive the information from the payer computer through the interface to the payer computer, create a credit transaction that debits funds from a transaction processor's bank and credits funds to a bank of the payee, create a debit transaction based on the information that debits funds from a bank of the payer and credits funds to the transaction processor's bank, and send both the debit transaction and the credit transaction to the banking network through the interface to the banking network on a banking day.

Embodiments of the present invention also provide a payment processing system having a host computer system configured to receive payment information via a network from a client computer, a data storage arrangement configured to store the payment information, and a settlement engine. The settlement engine is configured to receive payment information from the host computer system, initiate payment processing by transmitting a file comprising at least a portion of the payment information to a first financial institution, and transmit a message to a client computing system. The message includes at least a portion of the payment information. The settlement engine may be configured to receive payment information from the data storage arrangement. The host computer system may be configured to respond to requests for historical payment information by transmitting an electronic file to a user computer. The electronic file may include payment information. T he electronic file may include payment information from a particular consumer covering a specified period of time. The electronic file may include payment information to a particular client covering a specified period of time.

In another embodiment, a payment processing method includes receiving at a host computer system payment information from a client computer. The payment information relates to a payment from a consumer. The method also includes verifying at least a portion of the payment information, storing at least a portion of the payment information in a database, transmitting a first electronic file comprising at least a portion of the payment information to a financial institution, thereby initiating processing of the payment, transmitting a second electronic file comprises at least a portion of the payment information to a client computing system, and responding to a request for historical information by transmitting to a user computer system a third electronic file comprising at least a portion of the payment information.

The method also may include initiating an electronic transfer of funds to a client's financial institution representing the payment. The method also may include receiving an electronic transfer of funds from a consumer's financial institution representing the payment. The electronic transfer of funds to a client's financial institution may be initiated prior to receipt of the electronic transfer of funds from a consumer's financial institution. The method also may include receiving an electronic message comprising a rejection of the payment from a consumer's financial institution. The method also may include initiating an electronic withdrawal of funds from the client's financial institution. The method also may include transmitting to the client computing system a fourth electronic file that includes revised payment information. The third electronic file also may include payment information from a particular consumer covering a specified period of time. The third electronic file may include payment information to a particular client covering a specified period of time. The first electronic file may include additional payment information from a least one additional customer. The first electronic file may include information representing a rejection of an attempt to withdraw funds from a consumer's financial institution.

The payment information may include a checking account of the consumer from which the payment is to be made. The payment information may include a credit card account of the consumer from which the payment is to be made. The payment information may include a debit card account of the consumer from which the payment is to be made. The step of verifying at least a portion of the payment information may include contacting the client's computer system to obtain information relating to the payment information. The step of verifying at least a portion of the payment information may include consulting an electronic file provided by a client to obtain information relating to the payment information. The step of verifying at least a portion of the payment information may include using an algorithm specified by a client to evaluate at least a portion of the payment information. The step of using an algorithm specified by a client to evaluate at least a portion of the payment information may include checking the arrangement of numbers in an account number of the payment information. The step of verifying at least a portion of the payment information may include consulting a third party service to verify an ABA routing number of the payment information. The third party service may be provided by Thompson Financials.

The present invention relates to systems and methods for facilitating the payment of obligations by consumers. According to the present invention, a consumer accesses a web site operated by or on behalf of a payee to whom the consumer owes money. The consumer expresses an intention to pay at least a portion of the obligation owed to the payee. The consumer is presented with a payment screen having blanks for the consumer to complete that provide information necessary to complete the payment from the consumer to the payee. Such information may include the consumer's account number with the payee, the consumer's bank account number, the bank's ABA routing number, and the like. Appropriate security screens may be used to insure the consumer's account information remains private.

Once the consumer supplies the information, it is used to initiate the appropriate transactions through the ACH or other banking network. In a specific embodiment, the information is sent to a transaction processor. The transaction processor processes a debit transaction through the ACH network that withdraws funds from the consumer's bank account. The transaction processor also processes a credit transaction through the ACH network that deposits funds into the payee's bank account. In some embodiments, the transaction processor also sends posting information to the payee's accounting system that reflects the payment from the consumer to the payee.

In some embodiments of the present invention, the same transaction is used to withdraw funds from the consumer's bank and deposit the funds into the payee's bank. In other embodiments, however, the debit transaction results in a transfer of funds from the consumer's bank account to the transaction processor's bank account, and the credit transaction results in a transfer of funds from the transaction processor's bank account to the payee's bank account. The transaction processor may initiate the credit transaction contemporaneously with the debit transaction, for example in the same banking day or within one banking day. Because the processing of the transactions through the ACH network takes time, the transaction processor may have funds withdrawn from its bank account to pay the payee before the transaction processor receives funds from the consumer.

In some instances, the debit transaction cannot be completed. For example, the consumer may not have sufficient funds to complete the payment, the consumer may have initiated a “stop payment” relating to the transaction, or the like. In such cases, the transaction processor may initiate another transaction that removes funds previously credited to the payee's bank account. The transaction processor also may send posting information to the payee's accounting system to reflect the reversal of the transaction.

In some embodiments, the transaction processor consolidates a number of transactions with the payee's bank into a single transaction. For example, if the transaction processor initiates three deposits crediting a total of $1200 to the payee's bank and also initiates a $200 withdrawal from the payee's bank, the transaction processor may combine the transactions into a single deposit of $1000 from the transaction processor's bank to the payee's bank. The transaction processor also may consolidate multiple transactions with a consumer's bank.

The present invention provides the ability for a consumer to complete a payment to a payee in a short period of time. For example, the consumer may be able to complete a payment to the payee on or just before the payment due date without incurring a late penalty. The payee may provide an incentive for the consumer to make payments in this way because the transaction processor may credit the funds to the payee within one day or even on the same day in some examples. In return for processing the transaction, the transaction processor may charge a fee to the consumer, the payee, or both for the service.

Embodiments similar to those discussed herein are also discussed in U.S. Patent Pub. No. 2004/0210521, filed on Apr. 2, 2003, and U.S. Pat. No. 7,818,251, filed on Oct. 8, 2002, which claims priority to U.S. Provisional Patent Application No. 60/339,732, filed on Dec. 10, 2001, all of which are hereby incorporated by reference, for all purposes, as if fully set forth herein.

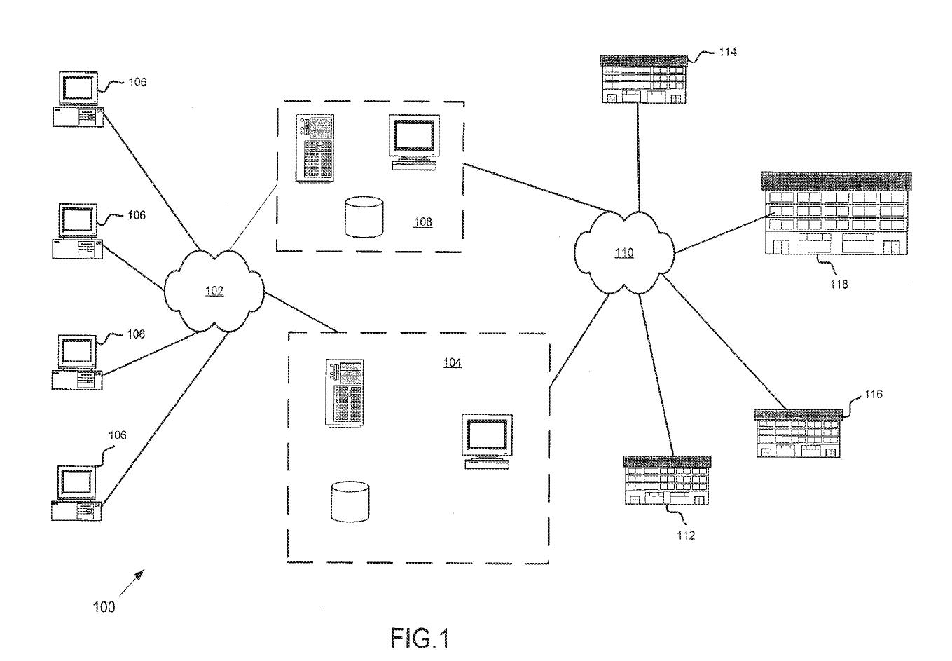

Having described the present invention generally, attention is directed to FIG. 1, which illustrates one exemplary embodiment of a payment processing system 100 according to the present invention. The present invention is not limited to the system 100. Those skilled in the art will recognize other possible embodiments of the present invention in light of the disclosure herein.

The system 100 includes a network 102 that enables communication among a host computer system 104, one or more consumer computing devices 106, and one or more payee computer systems 108. The network 102 may be any of a wide variety of networks, including optical or electrical networks, wired or wireless network, wide area or local area networks, virtual private networks, any combination of the foregoing, or the like. The host computer system 104, may be one or more of any of a wide variety of computing devices. For example, the host computer system may include mainframe processors, workstations, desktop computers, web servers, transaction processing computers, email servers, database servers, display devices, peripherals, and/or the like. The devices comprising the host computer system may be co-located in a single geographic area or distributed throughout a number of geographical areas. The host computer system 104 may be operated by or on behalf of a transaction processor. The consumer computing devices 106 may be any of a wide variety of computing devices, such as, desktop computers, laptop computers, workstations, personal digital assistants, and/or the like. The consumer computing devices may includes peripherals such as printers, display devices, modems, and/or the like. The payee computer systems 108 may include components similar to the host computer system 104, such as mainframe processors, workstations, desktop computers, web servers, accounting system processors, email servers, database servers, display devices, peripherals, and/or the like.

The system 100 also includes a banking network 110, which may be the same network as the network 102, or may be a different network. The banking network 110 enables the communication of banking transactions among the transaction processor's bank 112, a payee's bank 114, a consumer's bank 116, and a network operator 118. In a specific embodiment, the banking network 110 is the ACH network and the network operator 118 is the Federal Reserve.

The various computing devices of this example of the present invention may be programmed to perform the methods of the present invention. For example, the payee computer system 108 may be programmed to display web pages through an Internet browser at a consumer's computing device 106. Other examples of the programming of the computing devices of the present invention will become apparent in light of the disclosure herein.

The system 100 may be used to process payments between a consumer and a payee as previously described. Many consumers now use personal computers in the process of managing their financial affairs. Consumers receive advertisements and account information in the form of email from merchants and other businesses with whom they transact. Consumers also may use the Internet to access their account information and other information of interest from web sites representing the merchants and businesses. These emails and web pages may be generated at a computer system such as the payee computer system 108. In one example, a payee may send an email reminding a consumer that he has a payment due on an obligation the consumer incurred with the payee. In another example, the consumer may receive such a reminder upon accessing account information via the Internet. In either case, the payee may direct the consumer to a particular web page that will allow the consumer to make the payment.

The web page to which the payee directs the consumer may be hosted by a transaction processor at, for example, the host computer system 104. In a specific embodiment, the web page is designed such that the consumer appears to be interacting directly with the payee. For example, the web page may have the branding of the payee, and the URL (web site address) may be masked or otherwise altered to prevent alerting the consumer that he has left the computer system operated by the payee. It has been reported that such an arrangement is desired by payees, presumably because they have higher utilization rates from their consumers when consumers do not realize that another party is involved in the process. Thus, in an effort to provide a more desirable product to its clients, a financial services company interested in providing transaction processing services for its clients (payees) may design a system that receives payment information from consumers without alerting the consumers that the transaction processor is involved. Of course, many other examples are possible.

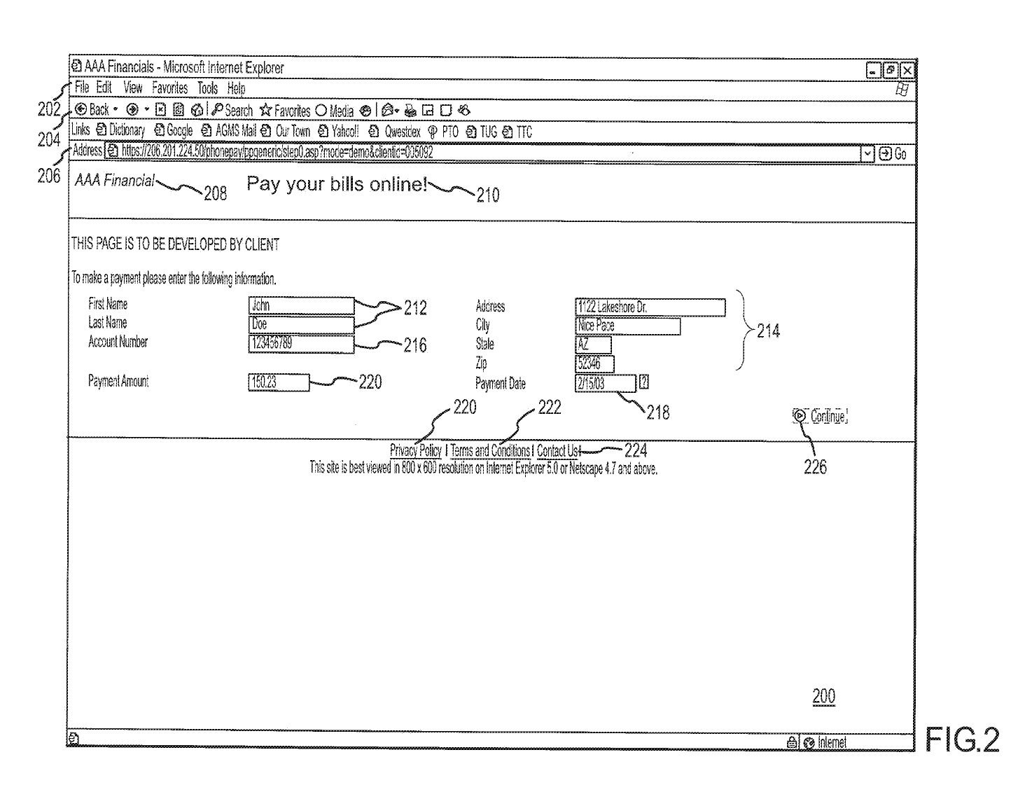

The payment web page may look like the example of a payment screen 200 pictured in FIG. 2. The payment screen 200 may be a web page displayed in a web browser, as is known in the art. The payment screen 200 may include a menu bar 202, navigation button bar 204, address bar 206, and other features common in web browser environments. With respect to the features of the present invention, the payment screen 200 may include a client logo 208 and a page title 210. The payment screen 200 also includes a number of data fields to be completed by the consumer to initiate payment, as will be explained.

The payment screen 200 includes data fields for the customer's name 212, address 214, account number 216, payment date 218, and payment amount 220. In some embodiments, the payment screen 200 may be pre-populated with information from the payee's records relating to the customer. For example, the consumer's account number with the payee may appear in the account number field 216. This information may be passed to the host computer system 104 by the payee computer system 108 at the time the consumer initiates the transaction. Alternatively, the payee periodically may pass an electronic file to the host computer system 104 that includes a “master list” of the payee's consumers. The host computer system 104 may consult this file to pre-populate information in the data fields of the display screens. The data fields may be fill-in-the-blank fields, or may include selection features such as drop-down menus. Many other examples are possible.

In some embodiments, the consumer may be able to future-date a payment. If the consumer wants a payment to be processed in the future, the consumer may enter a date in the payment date field 218 that is in the future. The system may, however, place a limit on how far in the future a consumer may date a payment.

The payment screen 200 also may include hyperlinks for information such as a privacy policy 220, terms and conditions 222, and contact information 224 for the payee or the transaction processor. A continue button 226 takes the customer to the next display screen in the sequence.

In some embodiments, security features may prevent unauthorized access by others than the consumer to a payment screen relating to a particular consumer. For example, the payment screen 200 may be accessed by the consumer by linking directly from an account information screen (not shown) that required the consumer to enter an account number, a user ID, a password, and/or the like. In other embodiments, the payment screen may be immediately preceded by a verification screen. The security features may be housed at either the payee computer system 108 or the host computer system 104 or elsewhere. Many other examples are possible.

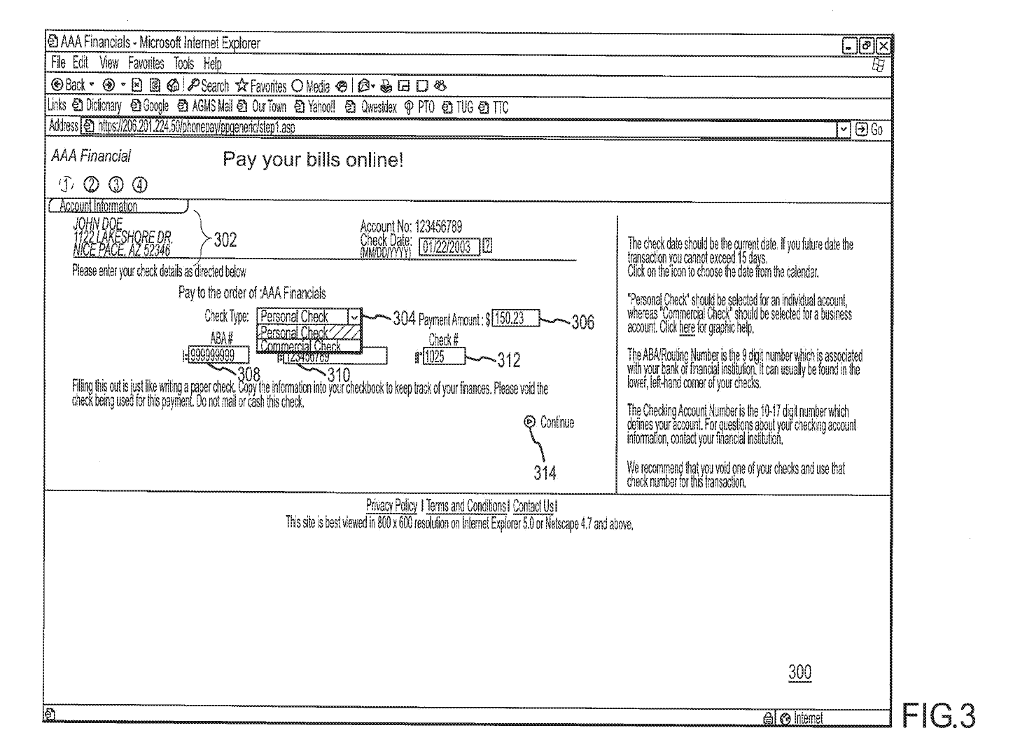

FIG. 3 illustrates an example of a bank information screen 300 that the consumer may encounter by selecting the continue button 226 of FIG. 2. The bank information screen may include consumer information 302 entered in the payment screen 200 of FIG. 2. The bank information screen also may include instructions for entering bank information. The bank information screen includes data fields for the type of check the consumer is using (e.g., either business or personal) 304, the payment amount 306 (which may be corrected if entered incorrectly in the previous screen), the consumer's bank's ABA #308, the consumer's bank account #310, and the check #312. Again, drop-down menus may facilitate entering information into the data fields. It is also possible that some of the information in the banking information screen 300 may be pre-populated, if, for example, the consumer previously paid the payee in a similar manner. A continue button 314 takes the consumer to the next display screen in the sequence.

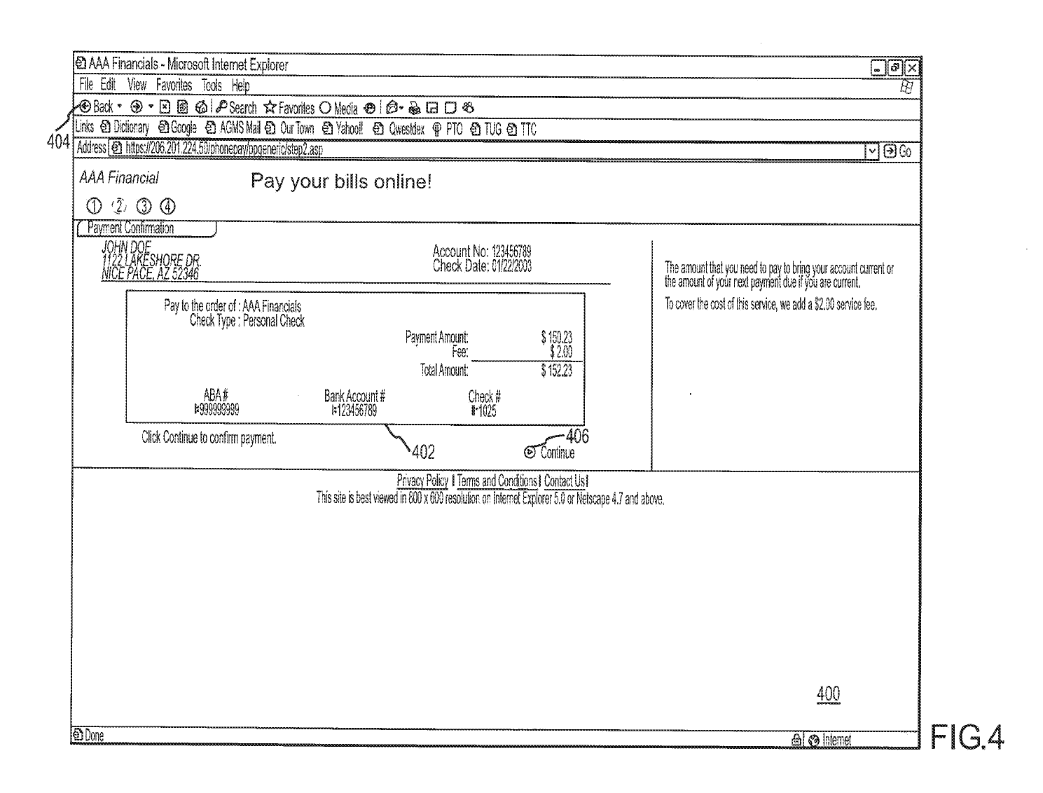

FIG. 4 illustrates a payment confirmation screen 400 according to the present invention. The payment confirmation screen 400 includes information previously entered by the consumer summarized in the form of a check 402 similar to one the consumer may have prepared had the consumer paid the debt using a traditional paper check. If any of the information is incorrect, the consumer may select the back button 404 to return to a previous screen in the sequence. If the information is all correct and the consumer wishes to proceed, the continue button 406 takes the consumer to the next display screen in the sequence.

The payment confirmation screen 400 also may display any taxes or fees that may be charged to the consumer in addition to the payment. The host computer system 104 may calculate the taxes and/or fees by consulting information is a database. The taxes and/or fees may be state-specific and/or payee specific. The information in the database may be updated periodically to integrate changes.

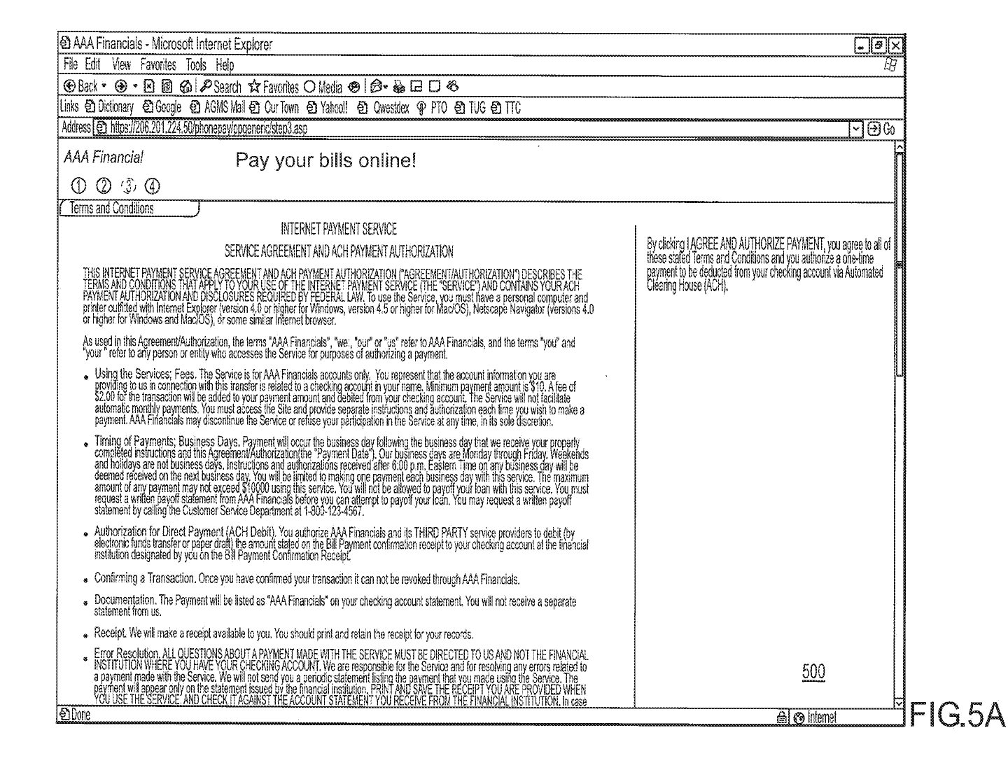

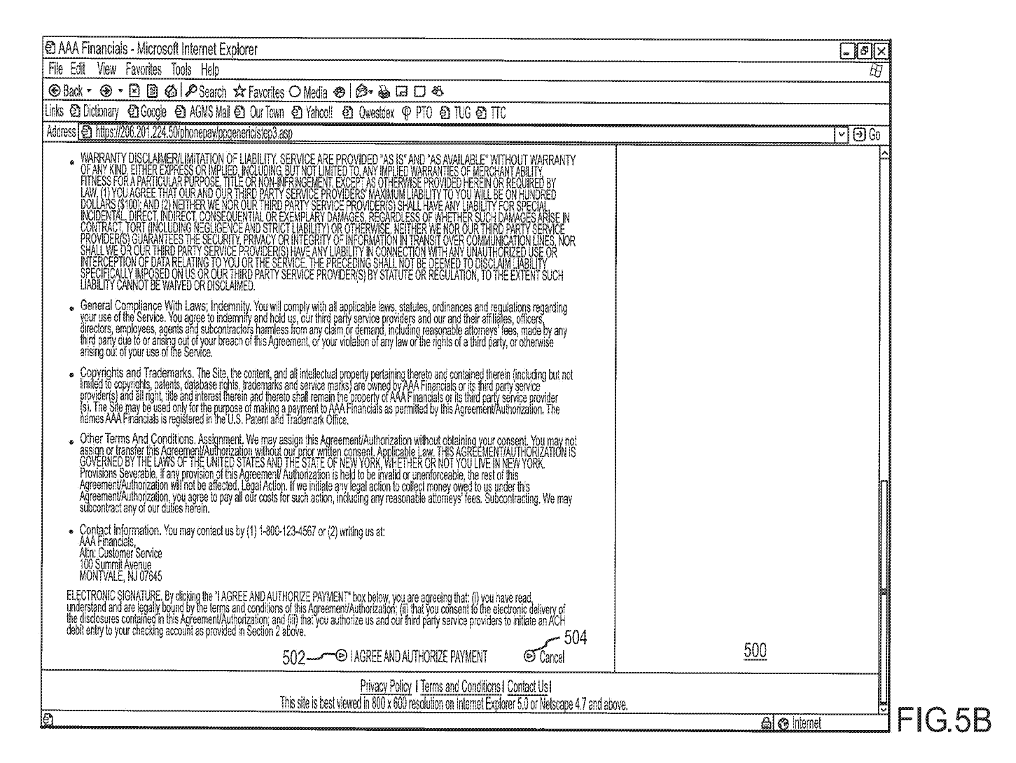

FIGS. 5A and B illustrate top and bottom portions, respectively, of a terms and conditions screen 500. The terms and conditions screen 500 provides the consumer with important information regarding his payment. In some embodiments, the consumer may be required to scroll to the bottom of the screen in order to reveal an accept button 502, which must be selected to complete the transaction. A cancel button 504 may allow the consumer to abort the payment.

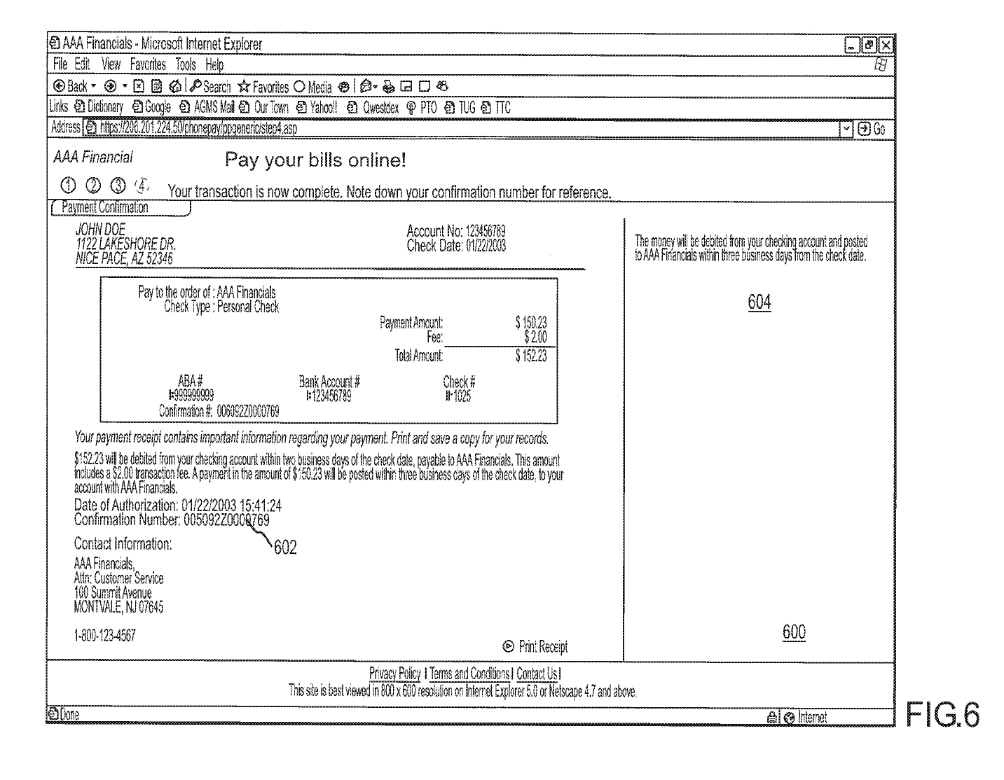

If the consumer accepts the terms and conditions by selecting the accept button 502, the final confirmation screen 600 of FIG. 6 is displayed. The final confirmation screen 600 includes the relevant information relating to the payment provided by the consumer, as well as, a confirmation number 602. Information relating to the processing of the payment also may be provided in an information area 604.

The preceding display screens of FIGS. 2-6 illustrate but one exemplary embodiment of a sequence of display screen that may be used to obtain payment information from a consumer for a payment to a payee. Many other examples are possible.

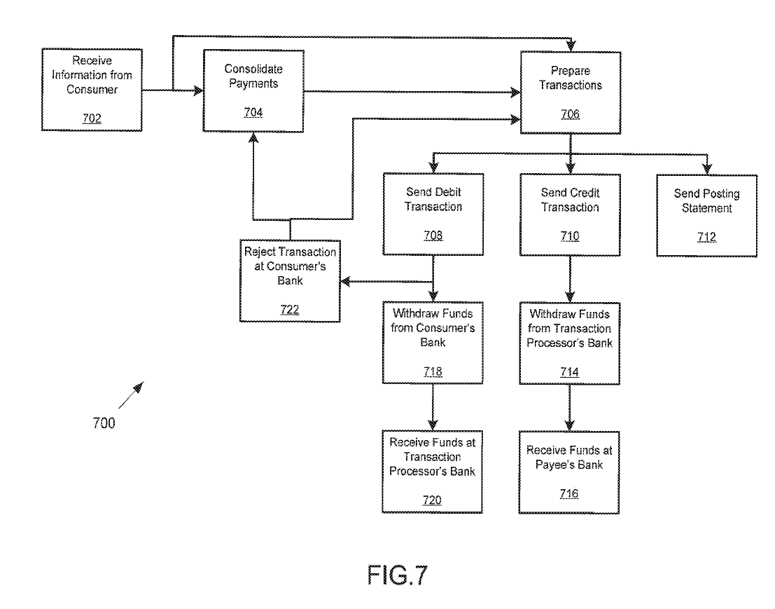

The information from a number of different payments from consumers may be collected at the host computer system 104 of FIG. 1 and periodically consolidated into a batch before being processed according to the method to be described hereinafter. In other embodiments, each payment may be processed as it is received. A method of processing a payment according to the present invention is described with respect to FIG. 7.

FIG. 7 is a flow diagram illustrating one embodiment of a method 700 of processing a payment from a consumer to a payee according to embodiments of the present invention. The method 700 begins at block 702 wherein information for the payment is collected from a consumer. As previously described, the information may be collected via a web site operated by a transaction processor on behalf of a payee and made to look like it is operated by the payee. The web site may include security features that limit access, as previously described. Optionally, at block 704, information from a number of different payments is consolidated into a batch.

At block 706, the information supplied by the consumer is used to generate one or more transactions. For example, a debit transaction may be prepared to withdraw funds from a consumer's bank, and a credit transaction may be prepared to deposit funds into a payee's bank. Although a single transaction could accomplish the transfer of funds from a consumer bank to a payee bank, the movement of funds through a banking network may not result in the payee being credited with receipt of funds for several days. Thus, a transaction processor, according to the present invention, transfers funds from its bank to the payee in the credit transaction and transfers funds from the consumer's bank to its bank in the debit transaction.

Also at block 706, a posting statement is prepared for the payee. The posting statement provides the payee with information relating to one or more payments. The posting statement may be sent to the payee via an email, or, in some embodiments, may result in entries directly into the payee's accounting system.

Block 706 also may include the consolidation of new payments with reverse payments that were, for one reason or another, returned from a consumer's bank. This may happen, for example, if a consumer stops a payment or has insufficient funds in his account to cover the payment.

At block 708, the debit transaction is processed through a banking network, such as the ACH network. At block 710, the credit transaction is processed through the banking network. At block 712, the posting statement is sent to the payee's computer system. The actions at blocks 708, 710, and 712 may take place simultaneously or within a relatively short time from one another. For example, the credit transaction may be sent during the same banking day as the debit transaction or within one day after.

The processing of transactions through the banking network may be regulated by particular rules. For example, it may be the case that the transaction processor must introduce the transactions through a qualified party, such as an Original Depository Financial Institution (ODFI). It may also be the case that the transactions must be sent to an operator of the network, such as the Federal Reserve. The network operator serves as a clearing house for transactions within the network. Other financial networks operate by different rules, and the present invention may be adapted accordingly.

At block 714, funds are withdrawn from the transaction processor's account. At block 716, funds are deposited into the payee's account. At block 718, funds are withdrawn from the consumer's account. At block 720, funds are deposited into the transaction processor's account. In some embodiments, the funds are deposited in the payee's bank at operation 716 within one banking day of the day that the customer initiates the payment at block 702. In some embodiments, the funds are not deposited into the transaction processor's account at operation 720 until at least one banking day after funds are withdrawn from the transaction processor's account at operation 714. Thus, the transaction processor may be “at risk” for the period of time between the withdrawal of funds from its account until funds are received from the consumer's bank.

As previously mentioned, the consumer's bank may return the debit transaction unprocessed. If this happens, the information is received at block 722, and the information is used in the preparation of transactions at block 706. Alternatively, the information is used at block 704 to consolidate multiple transactions.

The present invention also provides a payment processing system that may be accessed and used via the Internet or other network. The system provides the capability for servicing a number of clients simultaneously. Historical information is compiled, which assists the process of collecting from consumers. Built in verification processes further simplify the process of collecting from consumers and frustrate attempts by consumers to provide false or inaccurate information.

According to the present invention, an operator of a payment processing system provides access to its clients or their representatives via a network, such as the Internet. Clients may include retailers, banks, utility companies, or other such merchants that routinely provide merchandise or services to consumers on credit. The clients may use the system to provide a convenient method for their consumers to pay their debts, or the clients may use the system particularly for collecting on past due accounts. In either case the clients or third parties, such as collectors, acting on behalf of the clients, attempt to contact a consumer with an outstanding account balance. (Hereinafter, the term “collector” will be understood to refer to a person employed by a client working exclusively for the client, or a person not directly employed by a client but working on the client's behalf. A collector also may work for a number of different clients.) Collectors typically contact consumers by telephone, although different methods for contacting consumers is certainly possible. Once the collector is in contact with the consumer, the collector may obtain payment information from the consumer.

Payment information may include a checking account number and a bank identification number, such as an ABA (American Banking Association) number or Routing and Transit number. Additionally or alternatively, the payment information could include a credit card number or other account number that allows non-signatory payment authorization (e.g., telephone authorization). Other payment information may include the consumer's name and address, the client's name and address, a payment date, and the like. The collector assimilates the payment information by entering it into data fields of display screens transmitted by a host computer system to a computer used by the collector. The display screens may comprise web pages, and the collector may use a web browser to view the pages and interact with the host computer system that generates the web pages. As the data is entered, for example, as each data field is completed or as a page of data is completed, the data is transmitted to the host computer system.

As the host computer system receives the payment information, the host computer system may verify some or all of the information. Thus, if a consumer provides the collector with false, misleading, or inaccurate information, the collector may request correct information while still in contact with the consumer. Because some consumers having past due accounts may be notoriously difficult to contact, the present invention is particularly useful to clients because it may help to avoid needless repetition. For example, a collector having the means of the present invention to verify payment information in real time does not have to repeatedly contact the consumer to get revised information. If the consumer is providing incorrect information, in many cases, the collector knows right away. Further, being able to verify information also allows the collector to assess whether the consumer is truly attempting to satisfy an obligation. If a consumer continues to provide useless payment information, then the client is sooner able to transfer a past due account to the next stage of collections. Thus, the present invention may significantly reduce the amount of time wasted attempting to contact delinquent consumers and then re-contacting those consumers over the course of weeks or months attempting to get reliable payment information, only to eventually find out that the account must be written off. Of course, the verification process of the present invention also streamlines collection from paying clients who mistakenly provide inaccurate payment information.

In addition to verifying the validity of account numbers, balances, and the like, the present invention also may evaluate a consumer's payment history. For example, because the present invention stores historical payment information relating to consumers, a collector may be able to view a consumer's history with respect to NSF checks. As with a paper check, a checking account debit via an electronic funds transfer also may result in a return due to insufficient funds being in the consumer's checking account to cover the amount of the payment. Thus, if the consumer accumulates a history of NSF checks, collectors may be required to collect from consumers using other means, such as credit cards, or obtain a supervisor's approval.

Once acceptable payment information is received, the present invention initiates an electronic funds transfer to collect the funds from the consumer's bank and deposit the funds in a client's bank. Transfers may involve the federal funds network, the ACH (Automated Clearing House) network, or other acceptable electronic funds transfer system. Further, the present invention may include processes for complying with various federal and state laws regulating electronic funds transfers, particularly telephone-authorized transfers. For example, the present invention may cause a confirmation letter to be printed and sent to a consumer following an authorization by the consumer to transfer money from the consumer's checking account.

In addition to initiating the electronic funds transfer, the present invention also may be configured to transmit payment information directly to a client's accounting system. This further simplifies the collection process for clients. In some embodiments, operators of the present invention may transfer funds to the client's bank even before the operator receives the funds from the consumer's bank. Of course, the operator may need to withdraw the funds from the client's bank if the operator does not eventually receive payment from the consumer's bank. However, according to the present invention, transfers among financial institutions may be consolidated, thus lowering the cost to complete the transactions.

Many additional features are included in some embodiments of the present invention. For example, the present invention provides collectors the ability to schedule future payments, and to modify or cancel, pending payments. Also, the present invention provides authorized users with the ability to view historical information relating to certain clients and consumers. Further, operators of systems according to the present invention may customize various features to suit the needs of their clients, and different clients may have different features.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. For example, those skilled in the art know how to arrange computers into a network and enable communication among the computers. Additionally, those skilled in the art will realize that the present invention is not limited to processing payments through a banking network. Other networks, such as credit card networks, may be used as well. Accordingly, the above description should not be taken as limiting the scope of the invention, which is defined in the following claims.

What is claimed is:

1. A method for identifying similarities in instructional data and creating consolidated records for transmission and effectuation thereof, comprising:
receiving, at a specialized host computer system, a request to initiate an allocation from a first party to a second party;
transmitting, from the specialized host computer system to a directing computer, a request for information relating to the allocation;
receiving the information relating to the allocation from the directing computer at the specialized host computer system, wherein the information includes:
a quantity;
an identification of an institution associated with the first party; and
an indication of an institution associated with the second party;
consolidating, by the specialized host computer system, the information from the directing computer with information received from other parties making allocations into consolidated information;
determining, from the consolidated information, by the specialized host computer system, a first aggregate which includes:
the quantity; and
all quantities to be sent to the institution associated with the second party for other allocations associated with other parties making allocations in the consolidated information;
determining, from the consolidated information, by the specialized host computer system, a second aggregate which includes:
the quantity; and
all quantities to be received from the institution associated with the first party for other allocations associated with other parties making allocations in the consolidated information;
creating, by the specialized host computer system, an additive instruction based on the first aggregate that reduces resources from an institution associated with the specialized host computer system and correspondingly increases resources at the institution associated with the second party;
creating, by the specialized host computer system, a subtractive instruction based on the second aggregate that reduces resources from the institution associated with the first party and correspondingly increases resources at the institution associated with the specialized host computer system; and
sending both the additive instruction and the subtractive instruction to a network in communication with the institution associated with the first party, the institution associated with the second party, and the institution associated with the specialized host computer system.
